(19) United States
(12) Patent Application Publication
(10) Pub. No.: US 2024/0185751 A1
(43) Pub. Date: Jun. 6, 2024

(54) DISPLAY AND DRIVING METHOD THEREOF

(71) Applicant: E Ink Holdings Inc., Hsinchu (TW)

(72) Inventors: Wen-Yu Kuo, Hsinchu (TW); Kuang-Heng Liang, Hsinchu (TW)

(73) Assignee: E Ink Holdings Inc., Hsinchu (TW)

(21) Appl. No.: 18/474,229

(22) Filed: Sep. 26, 2023

(30) Foreign Application Priority Data
Dec. 1, 2022 (TW) 111146117

(51) Int. Cl. G09G 3/20

(52) U.S. Cl. CPC G09G 3/20; G09G 2300/0819; G09G 2300/0852; G09G 2310/08; G09G 2330/021

(57) ABSTRACT

A display and a driving method thereof are disclosed. The display includes a plurality of pixel circuits. Each of the pixel circuits includes a display unit, a first scanning transistor, an equivalent boosting capacitor, a second scanning transistor, and a third scanning transistor. The display unit receives a first reference voltage and is coupled to a first node. The first scanning transistor is coupled to the first node and receives a first scanning signal. The equivalent boosting capacitor is coupled between the first node and a second node. The second scanning transistor is coupled to the second node and receives a second scanning signal. The third scanning transistor is coupled to the second node and receives the first scanning signal.

### CROSS-REFERENCE TO RELATED APPLICATION

This application claims the priority benefit of Taiwanese application no. 111146117, filed on Dec. 1, 2022. The entirety of the above-mentioned patent application is hereby incorporated by reference herein and made a part of this specification.

### BACKGROUND

### Technical Field

The disclosure relates to a display. Particularly, the disclosure relates to a display and a driving method thereof that can reduce power consumption.

### Description of Related Art

Generally, a display may drive a light emitting-unit through a corresponding driving method according to the type of the light-emitting unit. For example, an electronic paper display drives electrophoretic particles to move for displaying. The electronic paper display needs to provide a driving signal with a higher voltage value for operation compared with a diode display. However, the existing display cannot reduce a voltage value or a current value of the driving signal under the premise of effectively driving the electrophoretic particles, resulting in a relatively large amount of power consumption.

### SUMMARY

The embodiments of the disclosure provide a display that can reduce a voltage value or a current value of a driving signal to reduce power consumption.

According to an embodiment of the disclosure, a display includes a plurality of pixel circuits. Each of the pixel circuits includes a display unit, a first scanning transistor, an equivalent boosting capacitor, a second scanning transistor, and a third scanning transistor. The display unit receives a first reference voltage and is coupled to a first node. The first scanning transistor is coupled to the first node and receives a first scanning signal. The equivalent boosting capacitor is coupled between the first node and a second node. The second scanning transistor is coupled to the second node and receives a second scanning signal. The third scanning transistor is coupled to the second node and receives the first scanning signal.

According to an embodiment of the disclosure, a driving method of a display is also provided. The display includes a plurality of pixel circuits. Each of the pixel circuits includes a display unit, a first scanning transistor, an equivalent boosting capacitor, a second scanning transistor, and a third scanning transistor. The driving method includes the following. A first reference voltage is received by the display unit. A first scanning signal is received by the first scanning transistor and the third scanning transistor. A second scanning signal is received by the second scanning transistor.

Based on the foregoing, in the display and the driving method thereof according to the embodiments of the disclosure, by the equivalent boosting capacitor coupled between the first scanning transistor and the second scanning transistor according to different scanning signals, the voltage value on the first node (i.e., output to the node of the display unit) may be increased to reduce the voltage value or the current value of the scanning signals (i.e., the driving signals), and power consumption may be reduced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a circuit block diagram of a display according to an embodiment of the disclosure.

FIG. 2 is a schematic cross-sectional view of the pixel circuit according to the embodiment of FIG. 1 of the disclosure.

FIG. 3 is a schematic diagram of a circuit design of the pixel circuit according to the embodiment of FIG. 1 of the disclosure.

FIG. 4A and FIG. 4B are schematic diagrams of operations of the pixel circuit according to the embodiment of FIG. 3 of the disclosure.

FIG. 5 is a schematic diagram of another circuit design of the pixel circuit according to the embodiment of FIG. 1 of the disclosure.

FIG. 6A and FIG. 6B are schematic diagrams of operations of the pixel circuit according to the embodiment of FIG. 5 of the disclosure.

FIG. 6C and FIG. 6D are schematic diagrams of operations of the pixel circuit according to the embodiment of FIG. 3 of the disclosure.

FIG. 7 is a schematic diagram of another circuit design of the pixel circuit according to the embodiment of FIG. 1 of the disclosure.

FIG. 8 is a flowchart of a driving method according to an embodiment of the disclosure.

### DESCRIPTION OF THE EMBODIMENTS

Some embodiments of the disclosure accompanied with the drawings will be described in detail below. The same reference numerals used in the following description and in different drawings will be regarded as the same or similar elements. These embodiments are only a part of the disclosure, and do not disclose all possible implementations of the disclosure. More specifically, these embodiments are examples of the claims of the disclosure.

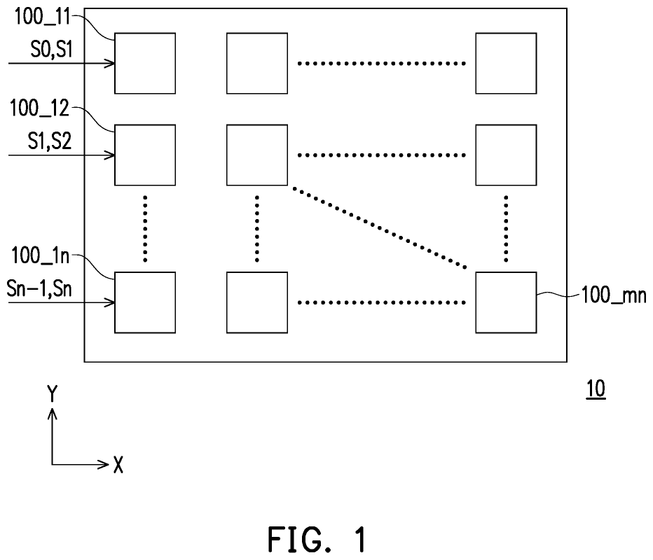

FIG. 1 is a circuit block diagram of a display according to an embodiment of the disclosure. With reference to FIG. 1, a display 10 may include a plurality of pixel circuits 100_11, 100_12, . . . , 100_1n, . . . , and 100_mn, and is described taking the plane formed by the X-axis and the Y-axis shown in FIG. 1 as an example. The pixel circuits 100_11 to 100_mn may be arranged into a matrix, where m and n are positive integers. In this embodiment, the display 10 may is an electronic paper display, for example.

Specifically, the pixel circuit 100_11 is in the first column and the first row, and is operated by a plurality of scanning signals S0 and S1. The pixel circuit 100_12 is in the first column and the second row, and is operated by a plurality of scanning signals S1 and S2. The pixel circuit 100_1n is in the first column and the n-th row, and is operated by a plurality of scanning signals Sn−1, Sn, and so on and so forth.

In this embodiment, the pixel circuit 100_11 and the pixel circuit 100_12 may share a scanning signal line for transmitting the scanning signal S1. The pixel circuit 100_12 and the pixel circuit 100_13 may share a scanning signal line for transmitting the scanning signal S2. The pixel circuit 100_1(n−1) and the pixel circuit 100_1n may share a scanning signal line for transmitting the scanning signal Sn−1, and so on and so forth. In other words, each adjacent two (e.g., any two adjacent rows) of the pixel circuits 100_11 to 100_mn may share the same scanning signal line.

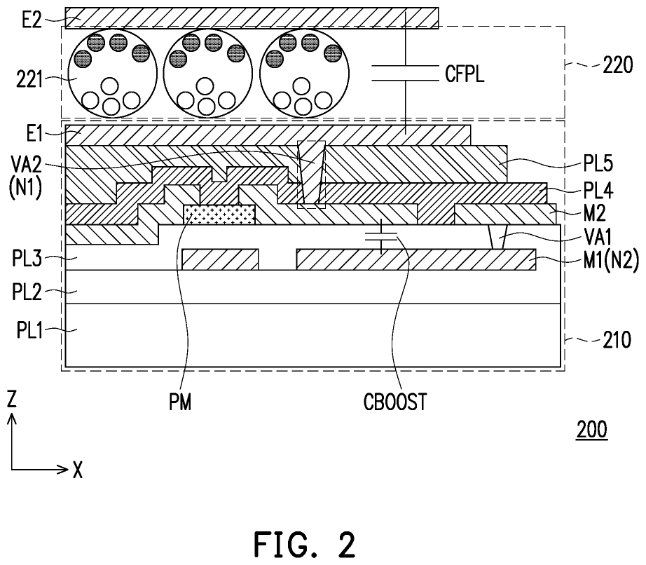

FIG. 2 is a schematic cross-sectional view of the pixel circuit according to the embodiment of FIG. 1 of the disclosure. With reference to FIG. 1 and FIG. 2, a pixel circuit 200 may be any one of the pixel circuits 100_11 to 100_mn, for example, and is described taking the plane formed by the X-axis and the Z-axis shown in FIG. 2 as an example.

In the embodiment of FIG. 2, the pixel circuit 200 may include a thin-film transistor (TFT) array substrate 210, a pixel electrode E1, a display unit 220, and an upper electrode E2. In this embodiment, the display unit 220 may be disposed between the upper electrode E2 and the pixel electrode E1, and form an equivalent pixel capacitor CFPL between the upper electrode E2 and the pixel electrode E1.

In this embodiment, the display unit 220 may include a plurality of microcapsule units 221 or microcup units 221. The units 221 may have electrophoretic particles of two colors (for example but not limited to white electrophoretic particles and black electrophoretic particles).

In this embodiment, the pixel circuit 200 may also include a glass layer PL1, a plurality of material layers PL2 to PL5, a material piece PM, metal layers M1 and M2, and a plurality of connecting vias VA1 and VA2. The material layers PL2 to PL5, the metal layers M1 and M2, the material piece PM, the connecting vias VA1 and VA2, and the pixel electrode E1 may each be formed in the thin-film transistor array substrate 210. The number and configuration of each structural layer of the embodiment of FIG. 2 are examples and the disclosure is not limited thereto. The glass layer PL1 may also be a substrate of other materials, such as a flexible plastic substrate, but the disclosure is not limited thereto.

To be specific, the glass layer PL1 may be form in the bottommost layer of the thin-film transistor array substrate 210. In the positive Z-axis direction, the material layer PL2, the metal layer M1, the material layer PL3 and the connecting via VA1, the metal layer M2 and the material piece PM, the metal layer M2 and the material layer PLA, and the material layer PL5 may be sequentially disposed between the glass layer PL1 and the pixel electrode E1. In other words, the metal layer M1 is disposed above the glass layer PL1. The metal layer M2 is disposed between the metal layer M1 and the pixel electrode E1.

In this embodiment, the material layers PL2 to PL5 are insulating materials to accommodate the metal layers M1 and M2 and the connecting vias VA1 and VA2. The connecting via VA1 may be filled with a conductive material to electrically connect the metal layers M1 and M2. The connecting via VA2 may be an extended part of the pixel electrode E1, for example, to electrically connect the metal layer M2. In some embodiments, the connecting via VA2 may be filled with a conductive material to electrically connect the metal layer M2 and the pixel electrode E1. The material piece PM is a semiconductor thin film layer.

In this embodiment, each of the metal layers M1 and M2 may be a metal trace or a metal block, for example, to be coupled (i.e., electrically connected) to other metal layers M1 and M2 or to the pixel electrode E1 through the connecting via VA1 and/or VA2. For example, the metal layer M1 may be coupled to the metal layer M2 through the connecting via VA1. The metal layer M2 may be coupled to the pixel electrode E1 through the connecting via VA2.

In this embodiment, the metal layers M1 and M2 and the connecting via VA2 may be electrically connected to a plurality of scanning transistors (not shown in FIG. 2). The scanning transistors may drive the display unit 220 according to a plurality of scanning signals and/or reference voltages to form an equivalent boosting capacitor CBOOST between the metal layer M1 and the metal layer M2.

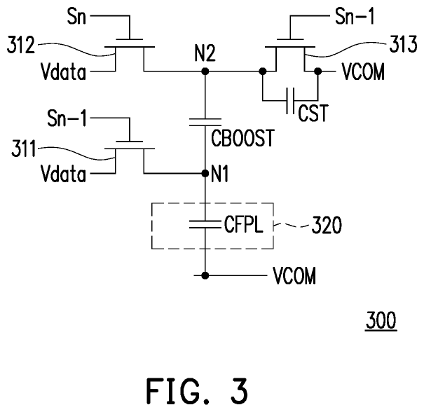

FIG. 3 is a schematic diagram of a circuit design of the pixel circuit according to the embodiment of FIG. 1 of the disclosure. With reference to FIG. 2 and FIG. 3, for example, the pixel circuit 200 may be an equivalent circuit of part of a pixel circuit 300. In the embodiment of FIG. 3, the pixel circuit 300 may include a display unit 320, a first scanning transistor 311, an equivalent boosting capacitor CBOOST, a second scanning transistor 312, and a third scanning transistor 313.

In this embodiment, the first terminal of the display unit 320 receives a first reference voltage VCOM. The second terminal of the display unit 320 is coupled to a first node N1. The display unit 320 may be driven according to the signal on the first node N1. In this embodiment, the display unit 320 may include an equivalent pixel capacitor CFPL. The equivalent pixel capacitor CFPL is coupled between the first reference voltage VCOM and the first node N1.

To be specific, the display unit 320 may correspond to the display unit 220 shown in FIG. 2. The first node N1 may correspond to the pixel electrode E1 or the connecting via VA2 extended from the pixel electrode E1 shown in FIG. 2. The first terminal of the display unit 320 receiving the first reference voltage VCOM may correspond to the upper electrode E2 shown in FIG. 2, and the upper electrode E2 may receive the first reference voltage VCOM. The equivalent pixel capacitor CFPL may correspond to the equivalent pixel capacitor CFPL shown in FIG. 2.

In this embodiment, the first scanning transistor 311 may be realized by an n-type metal-oxide-semiconductor field-effect transistor (NMOSFET), for example. The control terminal (i.e., the gate terminal) of the first scanning transistor 311 receives the first scanning signal Sn−1. The first terminal (i.e., the source terminal) of the first scanning transistor 311 receives a first data voltage Vdata. The second terminal (i.e., the drain terminal) of the first scanning transistor 311 is coupled to the first node N1.

In this embodiment, the equivalent boosting capacitor CBOOST is coupled between the first node N1 and a second node N2. To be specific, the equivalent boosting capacitor CBOOST may correspond to the equivalent boosting capacitor CBOOST shown in FIG. 2. The second node N2 may correspond to the metal layer M1 shown in FIG. 2. In some embodiments, the equivalent boosting capacitor CBOOST may be a physical capacitor, for example. The equivalent boosting capacitor CBOOST may be disposed in the thin-film transistor array substrate 210 shown in FIG. 2, and coupled to the connecting via VA2 (or the metal layer M2) and the metal layer M1.

In this embodiment, the second scanning transistor 312 may be realized by an NMOSFET, for example. The control terminal (i.e., the gate terminal) of the second scanning transistor 312 receives the second scanning signal Sn. The first terminal (i.e., the source terminal) of the second scanning transistor 312 receives a second data voltage. In the embodiment of FIG. 3, the second data voltage may be the same as the first data voltage Vdata. The second terminal (i.e., the drain terminal) of the second scanning transistor 312 is coupled to the second node N2.

In this embodiment, the third scanning transistor 313 may be realized by an NMOSFET, for example. The control terminal (i.e., the gate terminal) of the third scanning transistor 313 receives the first scanning signal Sn−1. The first terminal (i.e., the source terminal) of the third scanning transistor 313 receives a second reference voltage. In the embodiment of FIG. 3, the second reference voltage may be the same as the first reference voltage VCOM. The second terminal (i.e., the drain terminal) of the third scanning transistor 313 is coupled to the second node N2. In this embodiment, a parasitic capacitor CST of the third scanning transistor 313 may be exemplarily cross-connected between the first terminal and the second terminal of the third scanning transistor 313.

It should be noted that the first scanning transistor 311 and the third scanning transistor 313 are controlled by the same first scanning signal Sn−1 and may be turned on (i.e., conducted) or turned off during the same period. The first scanning transistor 311 (or the third scanning transistor 313) and the second scanning transistor 312 are controlled by different scanning signals Sn−1 and Sn and may be turned on or turned off during different periods.

In some embodiments, each of the first scanning transistor 311, the second scanning transistor 312, and the third scanning transistor 313 may be realized by a p-type metal-oxide-semiconductor field-effect transistor (PMOSFET), for example. In some embodiments, signals are inverse to the corresponding signals in this embodiment.

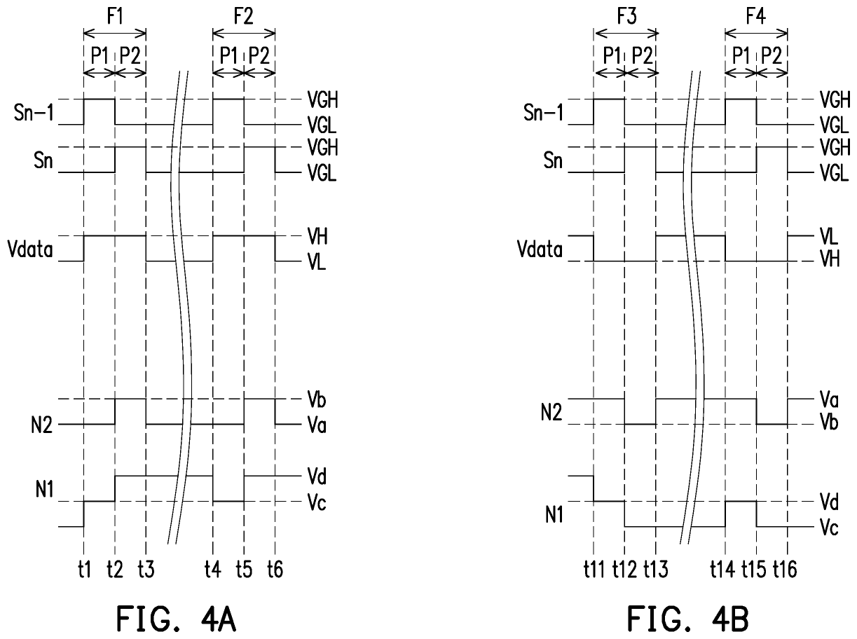

FIG. 4A is a schematic diagram of operations of the pixel circuit according to the embodiment of FIG. 3 of the disclosure. With reference to FIG. 3 and FIG. 4A together, in FIG. 4A, the horizontal axis represents the operation time of the pixel circuit 300, and the vertical axis represents the voltage value.

In the first image frame period F1, during the first period P1 (i.e., time t1 to t2) at the initial stage, the first scanning signal Sn−1 is enabled with an enabling voltage level VGH to turn on the first scanning transistor 311 and the third scanning transistor 313. The second scanning signal Sn is disabled with a disabling voltage level VGL to turn off the second scanning transistor 312. In this embodiment, the first scanning signal Sn−1 may be a rear-stage signal of the second scanning signal Sn, for example. In this embodiment, the enabling voltage level VGH may be a logic high level, for example. The disabling voltage level VGL may be a logic low level, for example.

The first data voltage Vdata may switch between voltage levels VH and VL. During the first period P1 (i.e., time t1 to t2), the first data voltage Vdata has the voltage level VH. In this embodiment, the voltage level VH may be a first voltage value V1, for example. The voltage level VL may be a second voltage value V2 lower than the first voltage value V1, for example. In this embodiment, the voltage level VL (i.e., the second voltage value V2) may be the ground voltage value (i.e., 0), for example.

The voltage value of the first reference voltage VCOM may be within a range of the voltage level VL to the voltage level VH of the first data voltage Vdata (i.e., within a range of voltage values 0 to V1). In this embodiment, the first reference voltage VCOM may be the ground voltage, for example.

The voltage on the second node N2 is pulled to the first reference voltage VCOM and has a voltage level Va (i.e., the ground voltage). The voltage on the first node N1 is pulled to the first data voltage Vdata and has a voltage level Vc (i.e., the first voltage value V1). At this time, the charge amount on the first node N1 may be expressed as shown in Formula (1) below. In Formula (1), QN1 is the charge amount on the first node N1, CBOOST is the capacitance value of the equivalent boosting capacitor CBOOST, CFPL is the capacitance value of the equivalent pixel capacitor CFPL, Vdata is the voltage value of the first data voltage Vdata (i.e., the first voltage value V1), and VCOM is the voltage value of the first reference voltage VCOM (i.e., 0).

QN1=CBOOST×(Vdata−VCOM)+CFPL×(Vdata−VCOM) Formula(1)

In the first image frame period F1, during the second period P2 (i.e., time t2 to t3) at the initial stage, the first scanning signal Sn−1 is disabled with the disabling voltage level VGL to turn off the first scanning transistor 311 and the third scanning transistor 313. The second scanning signal Sn is enabled with the enabling voltage level VGH to turn on the second scanning transistor 312. The first data voltage Vdata has the voltage level VH.

The voltage on the second node N2 is pulled to the first data voltage Vdata and has a voltage level Vb (i.e., the first voltage value V1). The voltage on the first node N1 has a voltage level Vd, and is related to the charge amounts stored in the equivalent boosting capacitor CBOOST and the equivalent pixel capacitor CFPL. At this time, the charge amount on the first node N1 may be expressed as shown in Formula (2) below. Reference may be made to the relevant description of Formula (1) for Formula (2), where VN1 is the voltage on the first node N1.

QN1=CBOOST×(VN1−Vdata)+CFPL×(VN1−Vdata) Formula(2)

Since the charge amount on the first node N1 is conserved, the charge amount during the first period P1 (shown in Formula (1)) is equal to the charge amount during the second period P2 (shown in Formula (2)). In addition, the capacitance value of the equivalent boosting capacitor CBOOST and the capacitance value of the equivalent pixel capacitor CFPL may be determined based on the actual design. Accordingly, as can be known according to Formulae (1) and (2), the voltage on the first node N1 may be about the sum of the voltage level of the first data voltage Vdata during the first period P1 and the voltage level of the first data voltage Vdata during the second period P2. In other words, the voltage on the first node N1 has a voltage level V4 that is about twice the voltage level VH (i.e., twice the first voltage value V1).

In the second image frame period F2, analogy may be made with reference to the relevant description of the pixel circuit 300 in the first image frame period F1 for the operation of the pixel circuit 300 during the first period P1 (i.e., time t4 to t5) at the operation stage, which will thus not be repeatedly described here.

FIG. 4B is a schematic diagram of operations of the pixel circuit according to the embodiment of FIG. 3 of the disclosure. With reference to FIG. 3 and FIG. 4B together, in FIG. 4B, the horizontal axis represents the operation time of the pixel circuit 300, and the vertical axis represents the voltage value. Analogy may be made with reference to the relevant description of the embodiment of FIG. 4A for the operation of the pixel circuit 300, which will thus not be repeatedly described here.

Compared with the embodiment of FIG. 4A, the first data voltage Vdata may switch between voltage levels VL and −VH. In this embodiment, the voltage level −VH may be the negative of the first voltage value V1 (i.e., −V1), for example. The voltage level VL may be the second voltage value V2 (e.g., 0), for example. In other words, the embodiment of FIG. 4A may be applied to the operation when the first data voltage Vdata has a positive voltage level, and the embodiment of FIG. 4B may be applied to the operation when the first data voltage Vdata has a negative voltage level.

During the first period P1 (i.e., time t11 to t12 or t14 to t15), the voltage on the second node N2 is pulled to the first reference voltage VCOM and has a voltage level Va (i.e., the ground voltage). The voltage on the first node N1 is pulled to the first data voltage Vdata and has a voltage level Vc (i.e., the negative of the first voltage value −V1).

During the second period P2 (i.e., time t12 to t13 or t15 to t16), the voltage on the second node N2 is pulled to the first data voltage Vdata and has a voltage level Vb (i.e., the negative of the first voltage value −V1). The voltage on the first node N1 may have a voltage level Vd (i.e., about twice the negative of the first voltage value −V1) according to Formulae (1) and (2).

It is worth mentioning here that, by the scanning transistors 311 and 313 and the scanning transistor 312 that are controlled by different scanning signals Sn−1 and Sn and turned on during different periods P1 and P2, the equivalent boosting capacitor CBOOST may raise up (or lower down) the voltage on the first node N1 according to the scanning signals Sn−1 and Sn, so that the display unit 320 is operated according to the voltage on the first node N1. As such, the shifted voltage may reduce the voltage value or the current value required by the scanning signals Sn−1 and Sn, and the scanning signal Sn−1 and/or Sn with high energy is not required to be provided to drive the display unit 320. Accordingly, the power consumption of the display may be reduced.

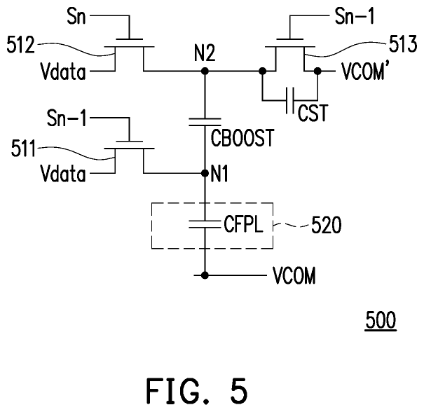

FIG. 5 is a schematic diagram of another circuit design of the pixel circuit according to the embodiment of FIG. 1 of the disclosure. With reference to FIG. 2 and FIG. 5, the pixel circuit 200 may be a partial equivalent circuit of a pixel circuit 500, for example. Analogy be may made with reference to the relevant description of the pixel circuit 300 shown in FIG. 3 for the pixel circuit 500, a display unit 520, a first scanning transistor 511, the equivalent boosting capacitor CBOOST, a second scanning transistor 512, and a third scanning transistor 513, which will not be repeatedly described here.

In this embodiment, the display unit 520 is coupled between the first reference voltage VCOM and the first node N1. The first scanning transistor 511 may receive the first data voltage Vdata. The second scanning transistor 512 may receive a second data voltage. In the embodiment of FIG. 5, the second data voltage may be the same as the first data voltage Vdata. The third scanning transistor 513 may receive a second reference voltage VCOM′. In the embodiment of FIG. 5, the first reference voltage VCOM is different from the second reference voltage VCOM′.

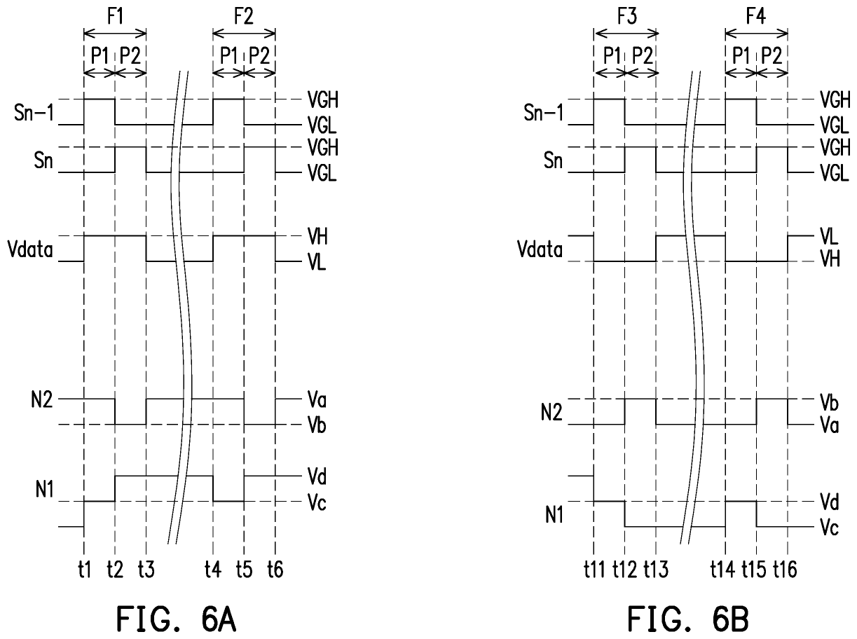

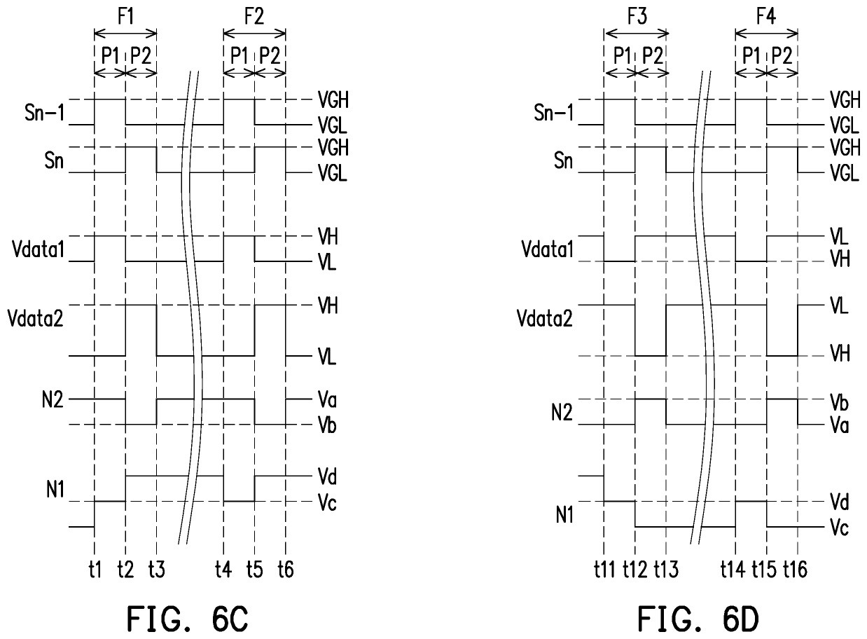

FIG. 6A is a schematic diagram of operations of the pixel circuit according to the embodiment of FIG. 5 of the disclosure. With reference to FIG. 5 and FIG. 6A together, analogy may be made with reference to the relevant description of the embodiment of FIG. 4A, which will thus not be repeatedly described here. In FIG. 6A, the horizontal axis represents the operation time of the pixel circuit 500, and the vertical axis represents the voltage value.

In the embodiment of FIG. 5 and FIG. 6A, for example, the voltage level VH of the first data voltage Vdata may be a third voltage value V3, and the voltage level VL of the first data voltage Vdata may be the ground voltage value (i.e., 0). The third voltage value V3 may be within a range of the first voltage value V1 to the second voltage value V2.

The voltage value of the first reference voltage VCOM may be within a range of the voltage level VL to the voltage level VH of the first data voltage Vdata (i.e., within a range of voltage values 0 to V3). In this embodiment, for example, the first reference voltage VCOM may be the ground voltage, and the second reference voltage VCOM′ may be a voltage value higher than the first reference voltage VCOM (e.g., the first voltage value V1).

During the first period P1 (i.e., time t1 to t2 or t4 to t5), the voltage on the second node N2 is pulled to the second reference voltage VCOM′ and has a voltage level Va (i.e., the first voltage value V1). The voltage on the first node N1 is pulled to the first data voltage Vdata and has a voltage level Vc (i.e., the third voltage value V3).

During the second period P2 (i.e., time t2 to t3 or t5 to t6), the voltage on the second node N2 is pulled to the first data voltage Vdata and has a voltage level Vb (i.e., the third voltage value V3). The voltage on the first node N1 may have a voltage level Vd (i.e., about twice the third voltage value V3) according to Formulae (1) and (2).

FIG. 6B is a schematic diagram of operations of the pixel circuit according to the embodiment of FIG. 5 of the disclosure. With reference to FIG. 5 and FIG. 6B together, analogy may be made with reference to the relevant description of the embodiment of FIG. 4B, which will thus not be repeatedly described here. In FIG. 6B, the horizontal axis represents the operation time of the pixel circuit 500, and the vertical axis represents the voltage value.

In the embodiment of FIG. 5 and FIG. 6B, for example, the voltage level VH of the first data voltage Vdata may be the negative of the third voltage value (i.e., −V3), the voltage level VL of the first data voltage Vdata may be the ground voltage value (i.e., 0), the first reference voltage VCOM may be the ground voltage, and the second reference voltage VCOM′ may be the negative of the first voltage value V1 (i.e., −V1).

During the first period P1 (i.e., time t11 to t12 or t14 to t15), the voltage on the second node N2 is pulled to the second reference voltage VCOM′ and has a voltage level Va (i.e., the negative of the first voltage value −V1). The voltage on the first node N1 is pulled to first data voltage Vdata and has a voltage level Vc (i.e., the negative of the third voltage value −V3).

During the second period P2 (i.e., time t12 to t13 or t15 to t16), the voltage on the second node N2 is pulled to the first data voltage Vdata and has a voltage level Vb (i.e., the negative of the third voltage value −V3). The voltage on the first node N1 may have a voltage level Vd (i.e., about twice the negative of the third voltage value −V3) according to Formulae (1) and (2).

FIG. 6C is a schematic diagram of operations of the pixel circuit according to the embodiment of FIG. 3 of the disclosure. With reference to FIG. 3 and FIG. 6C together, in FIG. 6C, the horizontal axis represents the operation time of the pixel circuit 300, and the vertical axis represents the voltage value.

For the operation details of another embodiment of the pixel circuit 300, with reference to FIG. 3 and FIG. 6C together, analogy may be made with reference to the relevant description of the embodiment of FIG. 4A, which will thus not be repeatedly described here. In the embodiment of FIG. 3 and FIG. 6C, the first data voltage Vdata may include a plurality of data voltages Vdata1 to Vdatan (not shown). The number and configuration of the data voltages Vdata 1 to Vdatan may be determined based on the actual design. For example, a combination of any two of the data voltages Vdata1 to Vdatan may be provided to the display unit 320 so that the display unit 320 displays grayscales. Another combination of other two of the data voltages Vdata1 to Vdatan may be provided to another display unit 320 so that this display unit 320 displays other specific colors.

As a concise realization example, the first data voltage Vdata shown in FIG. 6C is described with a combination of the data voltages Vdata1 and Vdata2. The data voltage Vdata1 may switch between voltage levels VH1 and VL1. During the first period P1 (i.e., time t1 to t2 or t4 to t5), the data voltage Vdata1 has the voltage level VH1. During the second period P2 (i.e., time t2 to t3 or t5 to t6), the data voltage Vdata1 has the voltage level VL1. In this embodiment, for example, the voltage level VH1 may be m times the first voltage value V1 (i.e., mV1), where m is a positive integer. For example, the voltage level VL1 may be the second voltage value V2 (e.g., the ground voltage value) lower than mV1.

The data voltage Vdata2 may switch between voltage levels VH2 and VL2. During the first period P1 (i.e., time t1 to t2 or t4 to t5), the data voltage Vdata2 has the voltage level VL2. During the second period P2 (i.e., time t2 to t3 or t5 to t6), the data voltage Vdata2 has the voltage level VH2. In this embodiment, for example, the voltage level VH2 may be n times the first voltage value V1 (i.e., nV1), where n is a positive integer greater than m. For example, the voltage level VL2 may be the second voltage value V2 (e.g., the ground voltage value) lower than nV1.

In other words, the first data voltage Vdata may switch between an enabling voltage level and the ground voltage value. The enabling voltage level may be any one of nV1, (n−1)V1, . . . , mV1 . . . . , 2V1, and V1, for example, and is enabled during the first period P1. The enabling voltage level may also be another one of nV1, (n−1)V1, . . . , mV1, . . . , 21, and V1, for example, and is enabled during the second period P2.

The voltage value of the first reference voltage VCOM may be within a range of the voltage level VL1 to the voltage level VH1 of the first data voltage Vdata (i.e., within a range of voltage values 0 to mV1), and within a range of the voltage level VL2 to the voltage level VH2 of the first data voltage Vdata (i.e., within a range of voltage values 0 to nV1). In this embodiment, for example, the first reference voltage VCOM may be the ground voltage.

During the first period P1 (i.e., time t1 to t2 or t4 to t5), the voltage on the second node N2 is pulled to the first reference voltage VCOM and has a voltage level Va (i.e., the ground voltage). The voltage on the first node N1 is pulled to the data voltage Vdata1 of the first data voltage Vdata and has a voltage level Vc (i.e., mV1).

During the second period P2 (i.e., time t2 to t3 or t5 to t6), the voltage on the second node N2 is pulled to the data voltage Vdata2 of the first data voltage Vdata and has a voltage level Vb (i.e., nV1). The voltage on the first node N1 may have a voltage level Vd (i.e., about the sum of mV1 and nV1) according to Formulae (1) and (2).

FIG. 6D is a schematic diagrams of operations of the pixel circuit according to the embodiment of FIG. 3 of the disclosure. With reference to FIG. 3 and FIG. 6D together, in FIG. 6D, the horizontal axis represents the operation time of the pixel circuit 300, and the vertical axis represents the voltage value. Analogy may be made with reference to the relevant description of the embodiment of FIG. 6C for the operation of the pixel circuit 300, which will thus not be repeatedly described here.

Compared with the embodiment of FIG. 6C, the data voltage Vdata1 of the first data voltage Vdata may switch between voltage levels VL1 and −VH1. In this embodiment, for example, the voltage level −VH1 may be the negative of m times the first voltage value V1 (i.e., −mV1), and the voltage level VL1 may be the second voltage value V2 (e.g., 0). The data voltage Vdata2 of the first data voltage Vdata may switch between voltage levels VL2 and −VH2. In this embodiment, for example, the voltage level −VH2 may be the negative of n times the first voltage value V1 (i.e., −nV1), and the voltage level VL2 may be the second voltage value V2 (e.g., 0). In other words, the embodiment of FIG. 6C may be applied to the operation when the data voltages Vdata1 and Vdata2 of the first data voltage Vdata both have positive voltage levels, and the embodiment of FIG. 6D may be applied to the operation when the data voltages Vdata1 and Vdata2 of the first data voltage Vdata both have negative voltage levels.

During the first period P1 (i.e., time t11 to t12 or t14 to t15), the voltage on the second node N2 is pulled to the first reference voltage VCOM and has a voltage level Va (i.e., the ground voltage). The voltage on the first node N1 is pulled to the data voltage Vdata1 of the first data voltage Vdata and has a voltage level Vc (i.e., −mV1).

During the second period P2 (i.e., time t12 to t13 or t15 to t16), the voltage on the second node N2 is pulled to the data voltage Vdata2 of the first data voltage Vdata and has a voltage level Vb (i.e., −nV1). The voltage on the first node N1 may have a voltage level Vd (i.e., about the sum of −mV1 and −nV1) according to Formulae (1) and (2).

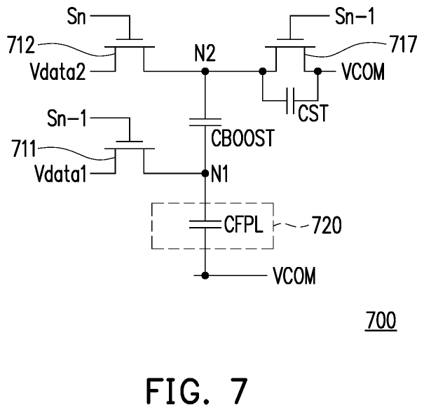

FIG. 7 is a schematic diagram of another circuit design of the pixel circuit according to the embodiment of FIG. 1 of the disclosure. With reference to FIG. 2 and FIG. 7, the pixel circuit 200 may be an equivalent circuit of part of a pixel circuit 700, for example. Analogy may be made with reference to the relevant description of the pixel circuit 300 shown in FIG. 3 for the pixel circuit 700, a display unit 720, a first scanning transistor 711, the equivalent boosting capacitor CBOOST, a second scanning transistor 712, and a third scanning transistor 713, which will not be repeatedly described here.

In this embodiment, the display unit 720 is coupled between the first reference voltage VCOM and first node N1. The first scanning transistor 711 may receive a first data voltage Vdata1. The second scanning transistor 712 may receive a second data voltage Vdata2. In the embodiment of FIG. 7, the first data voltage Vdata1 is different from the second data voltage Vdata2. The third scanning transistor 713 may receive the second reference voltage. In the embodiment of FIG. 7, the second reference voltage may be the same as the first reference voltage VCOM.

For the operation details of the pixel circuit 700, with reference to FIG. 7 and FIG. 6C together, analogy may be made with reference to the relevant description of the embodiment of FIG. 4A, which will thus not be repeatedly described here. In the embodiment of FIG. 7 and FIG. 6C, for example, the voltage level VH1 of the first data voltage Vdata1 may be the first voltage value V1, and the voltage level VL1 of the first data voltage Vdata1 may be the ground voltage value (i.e., 0). For example, the voltage level VH2 of the second data voltage Vdata2 may be the fourth voltage value V4, and the voltage level VL2 of the second data voltage Vdata2 may be the ground voltage value (i.e., 0). The fourth voltage value V4 may be higher than the first voltage value V1.

The voltage value of the first reference voltage VCOM may be within a range of the voltage level VL1 to the voltage level VH1 of the first data voltage Vdata1 (i.e., within a range of voltage values 0 to V1), or may be within a range of the voltage level VL2 to the voltage level VH2 of the second data voltage Vdata2 (i.e., within a range of voltage values 0 to V4). In this embodiment, the first reference voltage VCOM may be the ground voltage, for example.

During the first period P1 (i.e., time t1 to t2 or t4 to t5), the voltage on the second node N2 is pulled to the first reference voltage VCOM and has a voltage level Va (i.e., the ground voltage). The voltage on the first node N1 is pulled to the first data voltage Vdata1 and has a voltage level Vc (i.e., the first voltage value V1).

During the second period P2 (i.e., time t2 to t3 or t5 to t6), the voltage on the second node N2 is pulled to the second data voltage Vdata2 and has a voltage level Vb (i.e., the fourth voltage value V4). The voltage on the first node N1 may have a voltage level Vd (i.e., about the sum of the first voltage value V1 and the fourth voltage value V4) according to Formulae (1) and (2).

With reference to FIG. 7 and FIG. 6D again, for example, in some embodiments, the voltage level VH1 of the first data voltage Vdata1 may be the negative of the first voltage value V1 (i.e., −V1), and the voltage level VL1 of the first data voltage Vdata1 may be the ground voltage value (i.e., 0). For example, the voltage level VH2 of the second data voltage Vdata2 may be the negative of the fourth voltage value V4 (i.e., −V4), and the voltage level VL2 of the second data voltage Vdata2 may be the ground voltage value (i.e., 0). The first reference voltage VCOM may be the ground voltage, for example.

During the first period P1 (i.e., time t11 to t12 or t14 to t15), the voltage on the second node N2 is pulled to the first reference voltage VCOM and has a voltage level Va (i.e., the ground voltage). The voltage on the first node N1 is pulled to the first data voltage Vdata1 and has a voltage level Vc (i.e., the negative of the third voltage value −V1).

During the second period P2 (i.e., time t12 to t13 or t15 to t16), the voltage on the second node N2 is pulled to the second data voltage Vdata2 and has a voltage level Vb (i.e., the negative of the fourth voltage value −V4). The voltage on the first node N1 may have a voltage level Vd (i.e., about the sum of the negative of the third voltage value −V1 and the negative of the fourth voltage value −V4) according to Formulae (1) and (2).

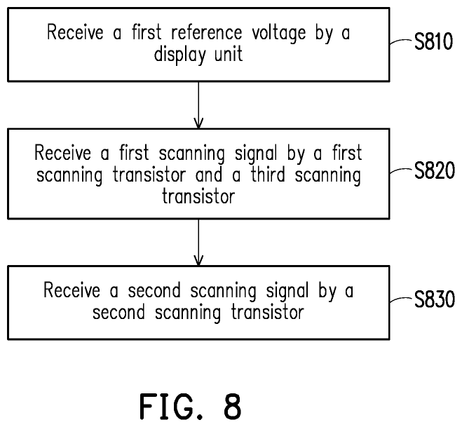

FIG. 8 is a flowchart of a driving method according to an embodiment of the disclosure. With reference to FIG. 1 and FIG. 8, the display 10 shown in FIG. 1 may perform steps S810 to S830 below to perform the driving method. Each of the pixel circuits 100_11 to 100_mn of the display 10 may be described taking the pixel circuit 300 shown in FIG. 3 as an example. With reference to FIG. 3 together, in step S810, the first reference voltage VCOM is received by the display unit 320. In step S820, the first scanning signal Sn−1 is received by the first scanning transistor 311 and the third scanning transistor 313. In step S830, the second scanning signal Sn is received by the second scanning transistor 312. The implementation details of steps S810 to S830 above have been described in detail in the embodiments and implementations above, and will not be repeatedly described here.

In summary of the foregoing, in the display and the driving method thereof according to the embodiments of the disclosure, by the scanning transistors that are controlled by the corresponding scanning signals, the equivalent boosting capacitor between the scanning transistors may shift (e.g., raise up or lower down) the voltage on the first node according to the scanning signals. Accordingly, the display unit may be operated according to the shifted voltage on the first node, and the voltage value or the current value required by the scanning signals may be reduced to reduce the power consumption of the display.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display comprising a plurality of pixel circuits, wherein each of the pixel circuits comprises:
a display unit receiving a first reference voltage and coupled to a first node;
a first scanning transistor coupled to the first node and receiving a first scanning signal;
an equivalent boosting capacitor coupled between the first node and a second node;
a second scanning transistor coupled to the second node and receiving a second scanning signal; and
a third scanning transistor coupled to the second node and receiving the first scanning signal.

2. The display according to claim 1, wherein the third scanning transistor further receives a second reference voltage.

3. The display according to claim 2, wherein the first reference voltage is the same as the second reference voltage.

4. The display according to claim 2, wherein the first reference voltage is different from the second reference voltage.

5. The display according to claim 2, wherein the first scanning transistor further receives a first data voltage, and the second scanning transistor further receives a second data voltage.

6. The display according to claim 5, wherein the first data voltage is the same as the second data voltage.

7. The display according to claim 5, wherein the first data voltage is different from the second data voltage.

8. The display according to claim 5, wherein a voltage value of the first reference voltage and a voltage value of the second reference voltage are with a range of a voltage value of the first data voltage to a voltage value of the second data voltage.

9. The display according to claim 1, wherein the first scanning transistor and the third scanning transistor are turned on during the same period, and the first scanning transistor and the second scanning transistor are turned on during different periods.

10. The display according to claim 1, wherein each adjacent two of the pixel circuits share the same scanning signal line.

11. The display according to claim 1, wherein the first node corresponds to a pixel electrode, the display unit is disposed between the pixel electrode and an upper electrode, and the upper electrode receives the first reference voltage,
wherein the display unit forms an equivalent pixel capacitor between the pixel electrode and the upper electrode.

12. A driving method of a display, wherein the display comprises a plurality of pixel circuits, and each of the pixel circuits comprises a display unit, a first scanning transistor, an equivalent boosting capacitor, a second scanning transistor, and a third scanning transistor, wherein the driving method comprises:
receiving a first reference voltage by the display unit;
receiving a first scanning signal by the first scanning transistor and the third scanning transistor; and
receiving a second scanning signal by the second scanning transistor.
